(19) United States
(12) Patent Application Publication
(10) Pub. No.: US 2026/0080029 A1
(43) Pub. Date: Mar. 19, 2026

(54) EFFICIENT DIFFERENTIAL TRANSMISSION OF QUBOS IN AN ORCHESTRATION SCHEME

(71) Applicant: Dell Products L.P., Round Rock, TX (US)

(72) Inventors: Diego Vrague Noble, Pelotas (BR); Ítalo Gomes Santana, Rio de Janeiro (BR); Miguel Paredes Quiñones, Campinas (BR)

(21) Appl. No.: 18/883,989

(22) Filed: Sep. 12, 2024

(51) Int. Cl. G06F 17/11; G06F 17/16

(52) U.S. Cl. CPC G06F 17/11; G06F 17/16

(57) ABSTRACT

One example method includes receiving, by a server from a node, a QUBO (quadratic unconstrained binary optimization) matrix, determining, by the server, whether or not the QUBO matrix is a difference QUBO matrix and, when the QUBO matrix is a difference QUBO matrix, searching a cache for a reference QUBO matrix that corresponds to the difference QUBO matrix, and when the reference QUBO matrix is found in the cache, building a QUBO matrix that corresponds to a QUBO to be solved by adding the reference QUBO matrix and the difference QUBO matrix together.

### TECHNOLOGICAL FIELD OF THE DISCLOSURE

One or more embodiments disclosed herein generally relate to resolution of QUBO (quadratic unconstrained binary optimization) problems. More particularly, at least some embodiments relate to systems, hardware, software, computer-readable media, and methods, for decreasing costs associated with transmitting a QUBO from a node to a server for solving.

### BACKGROUND

Quantum Annealing (QA) is a technology that employs specialized hardware to solve computationally difficult optimization problems. This hardware leverages quantum effects such as quantum entanglement and quantum tunneling to accelerate the solving process of optimization problems. With the current technology, QA computers have demanding requirements of physical space and energy consumption, making their usage limited to small-scale instances and/or expensive when dealing with large-scale ones. Therefore, most of the time, the capabilities of a QA are offered as a service to be remotely accessed and problems to be solved by the QA must be encoded in a Quadratic Unconstrained Binary Optimization (QUBO) format. Given the ubiquity of optimization problems, this can be an issue.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of upper triangular, and hashtable, representations of a QUBO.

FIG. 2 discloses aspects of a QUBO generation process for the so-called Traveling Salesman Problem (TSP).

FIG. 3 discloses a single QUBO problem configuration architecture, according to one embodiment.

FIG. 4 discloses a multi QUBO problem configuration architecture, according to one embodiment.

FIG. 5 discloses aspects of a client-side method, according to one embodiment.

FIG. 6 discloses aspects of a server-side method, according to one embodiment.

FIG. 7 discloses a sequence diagram, according to one embodiment, for the case when a QUBO diff is sent and its respective reference is present in a server cache.

FIG. 8 discloses a sequence diagram, according to one embodiment, for the case when a server does not have the reference QUBO and asks the client to repeat the process.

FIG. 9 discloses a sequence diagram, according to one embodiment, for when the client sends a QUBOₛₒₗᵥₑ instead of a QUBO_{diff}.

FIG. 10 discloses, for one experiment, the calculation of QUBO diff by the difference between QUBOₛₒₗᵥₑ and QUBO_{ref} followed by the removal of zeroed coefficients into a dictionary representation (sparse representation of a QUBO matrix).

FIG. 11 discloses, for the same experiment as regards FIG. 10, an example process for the reconstruction of QUBOₛₒₗᵥₑ.

FIG. 12 discloses aspects of an example computing entity configured and operable to perform any of the disclosed methods, processes, and operations.

### DETAILED DESCRIPTION OF SOME EXAMPLE EMBODIMENTS

One or more embodiments disclosed herein generally relate to resolution of QUBO (quadratic unconstrained binary optimization) problems. More particularly, at least some embodiments relate to systems, hardware, software, computer-readable media, and methods, for decreasing costs associated with transmitting a QUBO from a node to a server for solving.

In general, example embodiments comprise methods for efficient transmission of QUBOs from one or more nodes, such as an autonomous system or device for example, that generated or defined the QUBO, to an entity, such as a server, for the resolution of the QUBO. The solving entity may then return the solution to the node(s).

One example of such a method may comprise operations including: generating a QUBO to be solved; using the QUBO to calculate a QUBO difference; transmitting the QUBO difference to a server for solution; and, receiving, from the server, a solution for the QUBO that was generated. In an embodiment, this method may be performed at one or more nodes.

Another example of such a method may comprise operations including: receiving, from a node, a QUBO difference; using the QUBO difference to reconstruct a QUBO, which was used to generate the QUBO difference, to be solved; solving the QUBO; and, returning the solution to the node. In an embodiment, this method may be performed by, or at the direction of, a server that has access to quantum annealing hardware resources that can be used to solve a QUBO.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a QUBO may be efficiently provided, at least in part by the action of a node that generated the QUBO, to a server for solution. An embodiment may avoid, in many cases, the need for a node to transmit an entire QUBO to a server for solution. Various other advantages of one or more example embodiments will be apparent from this disclosure.

### A. Context for an Example Embodiment

The following is a discussion of aspects of a context for various embodiments. This discussion is not intended to limit the scope of the claims or this disclosure, or the applicability of the embodiments, in any way.

Combinatorial optimization (CO) problems belong to a class of problems which aims at finding the best possible solution among a finite but extensive set of possible solutions. This set is usually exponential in size, making efforts in developing advanced algorithmic strategies even more crucial, especially when these problems are large and arise in real-world scenarios, that is, intricate configurations. QA is an emerging technique that leverages quantum effects, such as entanglement and tunneling, to accelerate the solving process of CO problems. When QAs are prohibitive, alternatives to QA, such as the Simulated QA (SQA) or Simulated Annealing (SA), can also be successful to solve CO problems in classical hardware.

For any of these CO solvers, it has been useful to solve these problems after they have been modelled into a mathematical format called Quadratic Unconstrained Binary Optimization (QUBO) or, in short, QUBO problems, or simply QUBOs. Problems in this format are first defined into a single Hamiltonian function that contains the objective function and constraints, therefore, avoiding the explicit definition of constraints as usually expressed in traditional formats as Mixed-Integer Linear Programming (MILP). After the definition of the Hamiltonian function, the input data is processed in a method called compilation to derive a n×n QUBO matrix, where n is the number of binary variables of the QUBO. In the QUBO matrix, each cell consists of a rational number as coefficient for each pair of binary variables, namely, one variable for the row and another variable for the column. An embodiment may leverage this simple notation to enable CO problems generated by resource-constrained devices to be solved into a robust machine, such as quantum or classical computing machine for example. The following discussion first describes the roles of the client and server, then provides a broad description of a framework according to an embodiment.

As used herein, the word QUBO can have two meanings depending on the context: (1) a QUBO is an abstract form that represents a form of encoding an optimization problem in the specific format described elsewhere herein; and (2) a QUBO problem instance or QUBO matrix is a concrete form, or instance, of an optimization problem encoded as a QUBO—this concrete form may be understood as a final stage before the problem is solved—in this stage, all coefficients and variables are defined. It is noted that both QUBOs and Ising models are equivalent through a polynomial transformation therefore an embodiment may adopt only the QUBO representation, for the sake of brevity.

### A.1 QUBOs

In the modeling of an optimization problem as a QUBO, an embodiment may have a pseudo-Boolean function ƒ:{0,1}ⁿ [symbol] such that the aim is to find one attribution x ∈ {0,1}ⁿ of binary values that minimizes the value of ƒ, that is, min_{x∈{0,1}n} ƒ(x), as disclosed in “E. Boros, P. L. Hammer and G. Tavares, ‘Preprocessing of Unconstrained Quadratic Binary Optimization,’ Rutgers University, Piscataway, New Jersey, 2006,” which is incorporated herein in its entirety by this reference.

The function ƒ is of degree at most two, and is usually defined as a summation of linear and quadratic terms in the form:

$$f ( {x}_{1} , … , {x}_{n} ) = {c}_{0} + {\sum }_{j = 1}^{n} {c}_{j} {x}_{j} + {\sum }_{i = 1}^{n} {\sum }_{j = i + 1}^{n} {c}_{ij} {x}_{i} {x}_{j} \qquad Equation 1 - QUBO general form$$

In this form, c₀ is called the offset while the cᵢ for i=1, . . . , n terms are called linear terms and the cᵢⱼ for 1≤i<j≤n terms are called the quadratic terms. Each input—that is, each variable assignment for all variables—to this function has a corresponding energy value, thus the QUBO optimization problem can be expressed alternatively as min_{x∈ {0,1}n} xQx^{T} such that Q ∈ [symbol] ^{(n×n)}. The symmetric matrix Q is usually referred to itself as the QUBO.

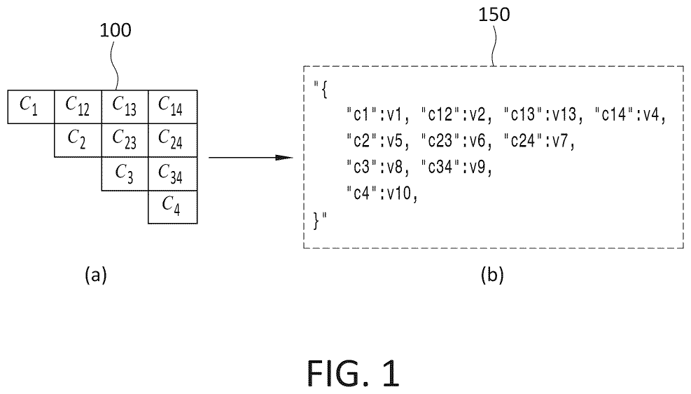

When modelling problems using the QUBO format, there are two commonly used representations: the symmetric matrix or the upper triangular matrix. The upper triangular matrix representation is preferred when one seeks to avoid transmitting or storing redundant information while the symmetric matrix representation is preferred when solving or manipulating the QUBO itself. An example of an upper triangular matrix 100 is depicted in FIG. 1a. This representation can also be transformed into a hash table, or dictionary, such as the example hash table 150 depicted in FIG. 1b. In particular, the upper triangular matrix 150 in FIG. 1a and hashtable 150 of FIG. 1b are forms of representing a QUBO and are interchangeable. The placeholders v1, v2, . . . v10 represent the floating-point coefficient values themselves.

The value of each coefficient is a floating point that depends on how the input instance of the problem and the problem's objective function was translated into the QUBO format. The first step is to produce a valid mathematical representation of problem's objective function and constraints that can be converted to Equation 1. Various representations for classic optimization problems may be found in “A. Lucas, ‘Ising formulations of many NP problems,’ Frontiers in Physics, vol. 2, 2014,” which is incorporated herein in its entirety by this reference.

### A.2 Quantum Annealing

With this mathematical representation, a process called compilation is executed to combine the mathematical definition along with the problem's instance input to produce a QUBO upper, or lower, triangular matrix. Next, a quantum annealer, or a simulated quantum annealer, may use this upper triangular matrix to find the variable assignment x that minimizes the energy of that QUBO. The mathematical representation is constant for a given problem configuration.

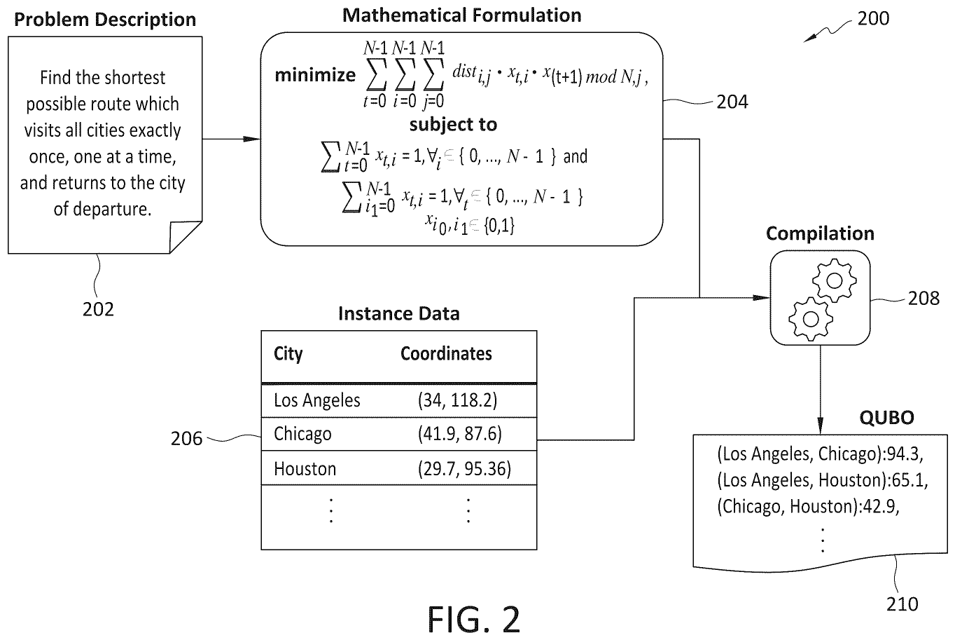

FIG. 2 illustrates this whole process, denoted at 200, using the Traveling Salesman Problem (TSP), which is a combinatorial optimization problem that can be modeled as QUBO. An initial problem description 202 is given, resulting into a valid mathematical formulation 204 for TSP. Next, the instance input, or instance data 206, for the problem is also given and compiled using the valid mathematical formulation to generate a compilation 208, therefore, producing an upper triangular matrix. A solution 210 to the QUBO may then be generated using the compilation 208. It is noted with respect to the example of FIG. 2, each set of instance data 206 must compile independently so as to generate a respective new QUBO. The values in FIG. 2 are placeholders only and variable names used were city names.

Solving an arbitrary QUBO, that is, finding a global minimum in an energy function, is an NP-hard problem, which is a class of problems that is not known to be solvable by exact methods in polynomial time on deterministic machines such as in classical computers. QUBOs can be solved heuristically using quantum annealing, a technique that leverages quantum phenomena such as quantum entanglement and quantum tunneling to explore the space of possible assignments more effectively in a specialized hardware.

### B. Overview of Aspects of One or More Embodiments

### B.1 Introduction

A problem addressed by one or more embodiments is to reduce the transmission costs associated with transmitting QUBO problems from a client to a server. This can be the case, for example, of a swarm of drones in an edge architecture that share a single channel or a satellite that must solve hard optimization problems, such as path planning as in the case of the TSP, but lack computational power to solve them locally. As well, an embodiment may be employed during the iterative and remote training of deep learning models such Quantum Boltzmann Machines, as this type of model generates many similar QUBOs.

One example embodiment employs caching and differential coding to decrease transmission costs. In other words, a client sends only the difference between the intended QUBO, that is, the QUBO to be solved, and a reference QUBO, which may be stored at the client and server sides. In generic terms, one embodiment may mitigate transmission costs/usage in sending QUBOs from a client to a server, as illustrated by the following example scenario:
1. There is a client-server architecture where QUBOs are generated/input in a single client, or multiple clients, which are sufficiently constrained to the point that the client(s) lack adequate computing resources, such as storage, processing, and memory for example, to timely solve its QUBO. On the server side, there is QA hardware able to solve any arriving QUBO problem, or an orchestrator that assigns any arriving QUBO problem to the most suitable QA hardware. Once the QUBO problem is solved, its solution is then sent back to its corresponding client node.
2. Each client node, which may comprise an autonomous system or device for example, produces a high throughput of similar QUBOs due to temporal correlation or any other factor. To illustrate, a forklift may, in near-real time, generate a QUBO problem for path planning, and another QUBO problem for stacking as many parcels as possible in its cargo.
3. Transmission cost of QUBOs between a client node and the server is costly, in terms of resources such as bandwidth and time for example, and it is a bottleneck to the system. Transmission cost may be interpreted as a unified cost factor for all involved costs, such as latency and network overheads for example. Thus, an embodiment may operate to reduce this unified transmission cost.

In an embodiment, a client and/or the server can tradeoff computing and other resources on its own side to reduce communication costs. More specifically, to reduce transmission costs in one embodiment, it is reasonable to spend computational on one or both sides as the transmission cost reduction is the main objective.

### B.2 Discussion

One example embodiment may operate to reduce the transmission cost c of sending a QUBO from a client node to a server node. An embodiment may assume that the QUBO cannot be solved in the client while the server node is able to fully perform it. Moreover, an embodiment may extend the applicability of the server to either solve the QUBO problem, or to orchestrate its dispatching to any (simulated) quantum annealer that better fits at that moment.

Following is a discussion of an embodiment that involves a case in which there is one client node and one server node. In particular, let P be an intended QUBO matrix that a stakeholder, such as an application, device, or user, for example, wants to solve on a client node using n number of qubits. Let R be a reference QUBO problem that is stored both in the client and server sides.

Given this, in one embodiment, the following operations are then executed on the client side. First, apply a function to compute D which is the difference between QUBOs P and R. As P and R are matrices of same size, a straightforward operation

D=R−P

is sufficient.

Next, send D to the server node. At each incoming D, the server node will compute/reconstruct

P=R+D

as R is assumed to be already on the server followed by solving P. An embodiment may assume s as the solution of P, which is sent back to client node.

This relatively simple scenario of a single node and a single server may, in an embodiment, be extended into a N:1 scheme, where N client nodes will transmit their respective D to the server node. This increase of nodes will also increase the complexity, particularly in the sense of (1) managing/scheduling effectively each pool of QUBO problems in both sides, but also in (2) sending the lowest possible cost in transmitting each respective client R to the server.

In one embodiment, these two issues are addressed by (1) adding an orchestration mechanism for scheduling each pool of QUBOs and (2) identifying the lowest cost c that those QUBOs can be reconstructed in the server using cached QUBOs. A further extension of one embodiment is also possible where different respective QUBO settings are expected each client node. As an example, autonomous vehicles may spawn QUBOs for their own respective path-planning, but also QUBOs for pick-and-collect parcels in the most efficient manner considering variables such as weight, size, and stack ordering.

As disclosed herein, various embodiment may possess one or more useful features and aspects, although no embodiment is required to possess any of such features or aspects. The following examples are illustrative, but not exhaustive.

An embodiment may provide caching of QUBOs to mitigate transmission costs and quick access to reference QUBOs. Since, in some circumstances, multiple problems are generated every moment, having a solid criterion, such as based on frequency, may help to determine the overall performance of an embodiment in a realistic use case. An embodiment may leverage basic operations between two QUBO matrices, such as addition and subtraction, to enable caching and solving of QUBOs in environments that include resource-constrained devices. As a final example, an embodiment may operate with the use of an orchestrator, or may serve as a front-end to any QA orchestration service or server.

It is noted, with respect to one embodiment, that differential coding and caching have been the basis of various developments. For example, the most used video codecs successfully employ specific and advanced differential coding techniques to compress video as a movie can be understood as a sequence of visually similar static frames. By way of contrast however, one embodiment may leverage both themes in a problem-solving scenario that can be applied to real-world use cases. Such use cases may include, for example, automated, that is, autonomous, vehicles as edge devices or satellites in deep space that need to optimize their path planning using a centralized server elsewhere but are constrained when using their communication channels to transmit data.

### C. Detailed Discussion of Aspects of an Embodiment

### C.1 Introduction

Reference is made here to a particular client node i as an entity that generates a QUBO matrix QUBOₛₒₗᵥₑ but cannot solve it with any approach. For example, a client node could be an autonomous drone that needs to traverse a large area, while considering stochastic variables about weather, weight, and others, at minimal fuel consumption, thus, spawning a complex QUBO problem to be solved as soon as possible so that the drone can continue to operate as needed. As a way of obtaining a solution sₛₒₗᵥₑ for any QUBOₛₒₗᵥₑ, node i must send QUBOₛₒₗᵥₑ to be solved in a central node, such as a server for example, and then wait until the server returns sₛₒₗᵥₑ. Due to the complexity of solving QUBOₛₒₗᵥₑ, which contains an exponential number of solutions proportional to the size of the problem, an embodiment may assume that this complexity is prohibitive for i in terms of its implemented hardware or the required time to obtain sₛₒₗᵥₑ. Therefore, exchanging (QUBOₛₒₗᵥₑ,sₛₒₗᵥₑ) over the network becomes a justifiable design decision in these circumstances.

In general terms, a network composed of a large set of client nodes I={i₁, . . . , iₘ} is likely to eventually create huge communication bottlenecks when every i ∈ I actively seeks to send QUBOs over the communication channels. To make matters worse, this will compound heavily into their solution waiting time. As a way of improving the network efficiency, an embodiment may operate by extracting and sending the payload of QUBOₛₒₗᵥₑ to the server using an auxiliary QUBO matrix, or QUBO_{ref}, stored both in the client and server sides. The payload, or QUBO diff, when transmitting data over the network is computed by calculating the difference between QUBOₛₒₗᵥₑ and QUBO_{ref}, discussed below, on a cell-wise matrix subtraction and removing all cells whose coefficients equal to zero.

As an example of this subtraction, consider an arbitrary cell (i,j) having 3.14 as coefficient in QUBOₛₒₗᵥₑ while, in QUBO_{ref}, a coefficient of 2.71, thus, resulting in a coefficient of 0.43 (that is, 3.14 minus 0.43 is equal to 2.71) in (i,j) of QUBO_{diff}. After removing all cells from QUBO_{diff} that are equal to zero, QUBO_{diff} will likely become a sparse matrix, that is, a matrix containing fewer elements than QUBO_{diff} before those cells were removed, that can be more efficiently represented as a hash map or any proper data structure that maps each pair of row and column and its coefficient, that is, in a sparse matrix format. For the purposes of discussion, by not by way of limitation, the following discussion makes reference to using a hash map, or a dictionary, as a data structure resulting from the transforming of QUBO_{diff} by removing the zero cells.

On the client side, in an embodiment, QUBO problems of different settings may be generated at any moment. For example, an autonomous device such as forklift must visit a set of checkpoints at minimum traversal cost while, at each checkpoint, the forklift must stack parcels in an optimal way to avoid any dangerous outcome, such as dropping a parcel for example, after leaving the checkpoint. This dynamic implies that these two optimization problems are spawned in near real time and, therefore, increasing the data throughput from the client side to the server.

For the sake of simplicity, but not by way of limitation, one embodiment may be described with reference to the example of a single QUBO problem configuration. For this example, in the generation of the very first QUBOₛₒₗᵥₑ in a client node, if QUBO_{ref} does not exist, then QUBOₛₒₗᵥₑ is sent directly to the server. In this case, the next QUBOₛₒₗᵥₑ generation, the QUBOₛₒₗᵥₑ from the past iteration will become QUBO_{ref}. An alternative embodiment may consider that QUBO_{ref} is downloaded from the server using an arbitrary criterion, such as the most used QUBO_{ref} in the server node, for example. Moreover, throughout time, QUBO_{ref} may be changed to increase efficiency where one embodiment may consider replacing completely an outdated QUBO_{ref} to another QUBO matrix or only some target matrix cells by checking if QUBO_{diff} is consecutively getting larger. In an embodiment, every change in QUBO_{ref} is also be synchronized with the same QUBO_{ref} in the server. One embodiment may provide a pool of QUBO_{ref} in each client node that will depend on the client node storage capabilities. In this case, each generated QUBOₛₒₗᵥₑ will be tested against all QUBO_{ref} in the pool and the smallest QUBO_{diff} is sent to the server. As a final remark, every transmission from the client node to the server stands for the pair (QUBO_{diff}, ID_{ref}), where the first element is the actual cell-wise differences while the second element is the QUBO_{ref} unique identifier used to obtain QUBO_{diff}.

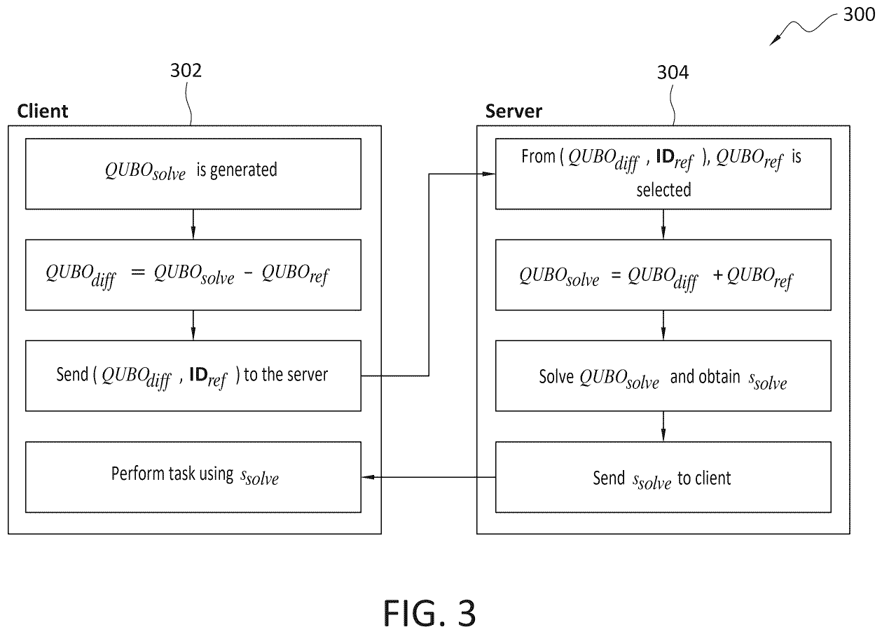

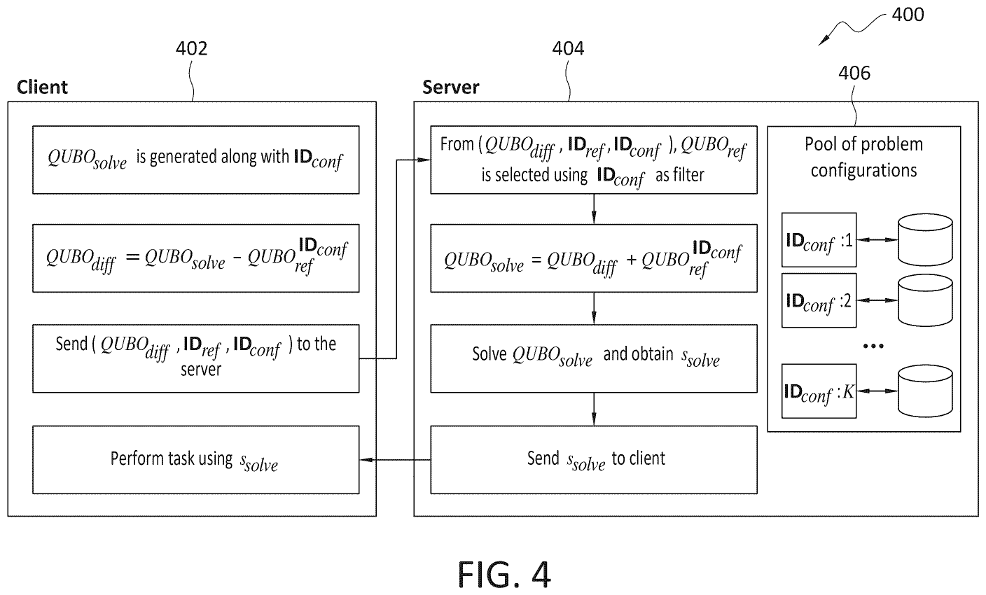

With reference now to FIG. 3, an example single problem configuration architecture 300 is disclosed that includes two nodes, namely, a client 302 and a server 304 that are operable to communicate with each other. On the server 304 side, an embodiment may assume that there exists a pool, as shown in the example of FIG. 4, of QUBO matrices to be used as reference along with an identifier for each. At each input (QUBO_{diff}, ID_{ref}) to the server 304, the identifier ID_{ref} is used to retrieve its corresponding QUBO_{ref} from the pool. Once this is done, the server 304 then reconstructs QUBOₛₒₗᵥₑ by a simple addition operation between QUBO_{diff} and QUBO_{ref}. The QUBOₛₒₗᵥₑ is then solved using any solver able to solve QUBO problems, such as Quantum Annealers, Simulated Quantum Annealers, and Simulated Annealing. The solution sₛₒₗᵥₑ is obtained after resolving QUBOₛₒₗᵥₑ and it is returned to the client node 302.

Another example embodiment may deal with multiple problem configurations, for example, logistic, scheduling, path planning, and bin packing, as illustrated in FIG. 4, which discloses an example of a multi problem configuration architecture 400 that comprises a client 402 configured to communicate with a server 404 that comprises, or accesses, a pool 406 of problem configurations. In this approach, each problem configuration will be identified by a unique ID conf. As a result, every transmission of (QUBO_{diff}, ID_{ref}) from the client node 402 to the server 404 may also include ID conf, that is, (QUBO_{diff}, ID_{ref}, ID conf). At the server 404 side, ID conf will be used to select the right pool 406 of problem configurations, then selecting the ID_{ref} for the QUBO reconstruction.

### C.2 Discussion

In one embodiment, the reference QUBO may be updated every k transmissions. This would mean that a client may use a fixed-size reference window. In another embodiment, the client may send a new reference QUBO only in certain conditions such as a change in environment, for example, when the configuration in the path-planning has changed, or when a difference QUBO pass a certain threshold of coefficients such as, for example, half, or more coefficients of the difference QUBO have changed, enabling the implementation and use of dynamic size reference window. From the point of view of the server, the reference window may be of no or little relevance.

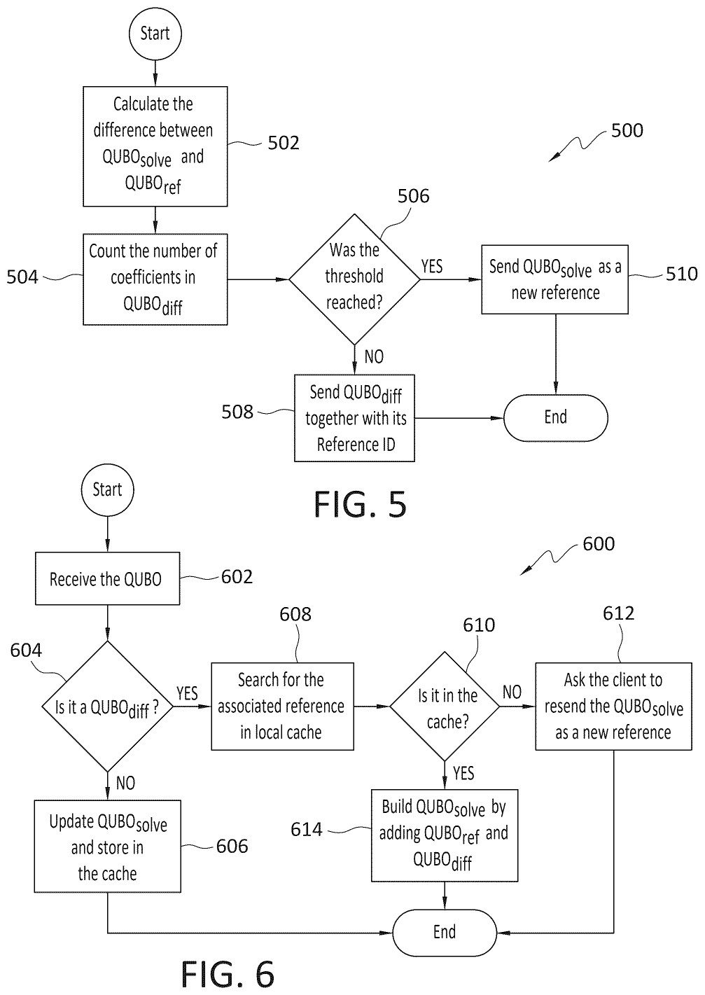

From the point of view of a single client, a process flow may be employed in one embodiment that uses a threshold on the number of coefficients in QUBO_{diff} to decide which QUBO should be transmitted. This threshold value could serve to fine tune the system because it can control the system “eagerness” to send reference QUBOs more frequently. An example of this process is disclosed in FIG. 5, which discloses a method 500 comprising a sequence of operations performed at a client, considering that a threshold is used to decide if a QUBO_{diff} or a QUBOₛₒₗᵥₑ is to be send over the communication channel.

In particular, and with continued reference to the example of FIG. 5, the method 500, which may be wholly performed by, or at the direction of, a client node, may begin with the calculation 502 of a difference between a QUBO to be solved, and a reference QUBO. This calculation 502 may result in the definition of a difference QUBO, whose coefficients may then be counted 504. Next, a determination 506 is made as to whether or not the number of QUBO coefficients exceeds a threshold. If not, the difference QUBO, and its Reference ID, are then sent 508 by the node to the server for solution. On the other hand, if it is determined 506 that the number of QUBO coefficients has met or exceeded the threshold, the node may send 510 the QUBO to be solved to the server. Thus, the QUBO to be solved becomes the new reference QUBO.

With reference next to the example of FIG. 6, there is disclosed a method 600 that may be performed at a server, in connection with the method 500 performed by a node. In particular, FIG. 6 discloses a method 600 including a sequence of operations that may be performed by a server, or other node, after receiving the QUBO from client. Note that when a QUBO_{diff} type of QUBO arrives at the server but its respective QUBO_{ref} is not present, the server needs to ask the client the correct reference QUBO, implying that this process will need to be repeated from the start. FIG. 6 omits the orchestration and solving steps in the interest of brevity.

In general, and with continued reference to the example of FIG. 6, when an arbitrary QUBO arrives at the server, the server needs to identify the kind of QUBO and whether that QUBO could be correctly rebuilt in the case a QUBO_{diff}. This embodiment considers that in the case that a QUBO_{ref} is not present, the client must send a new reference, that is, the client is asked to send QUBOₛₒₗᵥₑ in its entirety.

The example method 600 may begin when the server receives 602 a QUBO from a client. A check may be performed 604 to determine if that QUBO is a difference QUBO or not. If not, the method 600 may proceed to 606, where it may be assumed that the QUBO that was received 602 is a QUBO to be solved, and that QUBO to be solved may be used to update 606, that is, replace, the then-current QUBO to be solved, and the new QUBO to be solved, as determined at 604, may be stored in a cache by the server.

If it is determined 604 that the QUBO that was received at 602 is not a difference QUBO, a search 608 may then be performed for the associated Reference ID of that QUBO in a local cache of the server. If it is determined 610 that the QUBO is not in the cache, the server may ask 612 the client to resend the QUBO to be solved to be used at the server as the reference QUBO. On the other hand, if the QUBO is determined 610 to be present in the cache, then the QUBO to be solved may be built 614 by adding the reference QUBO to the difference QUBO.

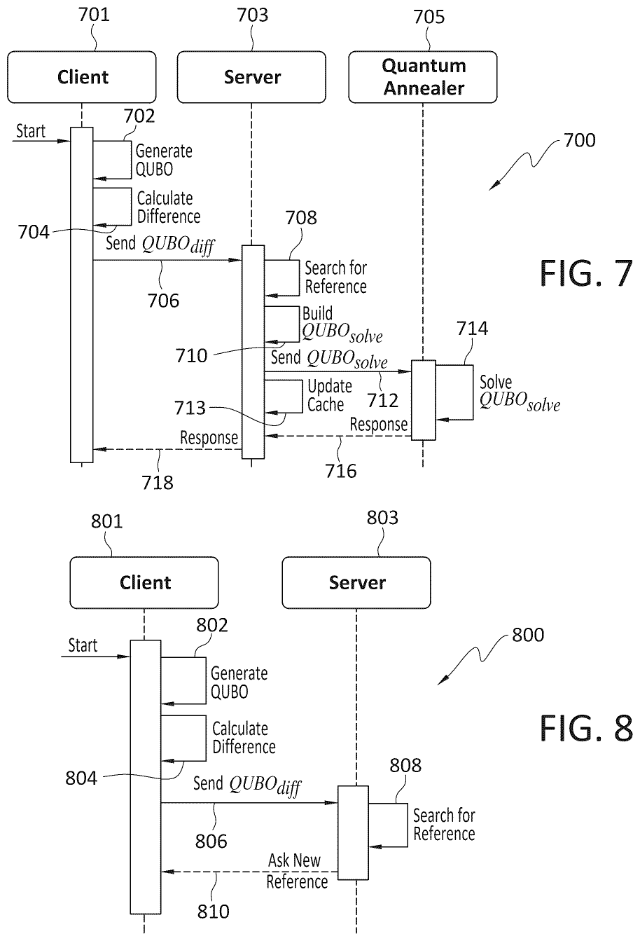

With reference now to the example of FIG. 7, a method 700 is disclosed that may be implemented in the case when the client sends QUBO_{diff} whose respective QUBO_{ref} is present on the server cache. In an embodiment, this may be the most desirable path in terms of reduction of transmission cost.

The example method 700 may be implemented in conjunction with a client 701, server 703, and quantum annealer 705. The method 700 may begin when the client 701 generates 702 a QUBO to be solved, and calculates 704 a difference QUBO based on a difference between the QUBO to be solved and a reference QUBO. The difference QUBO may then be sent 706 by the client 701 to the server 703. The server 703 may search 708 for the reference QUBO in a local cache and when the reference QUBO is found, build 710 the QUBO to be solved, using the difference QUBO and the reference QUBO. The QUBO to be solved may then be sent 712 by the server 703 to the quantum annealer 705 which may then solve 714 the QUBO to be solved, and return 716 the solution to the server 703, which may then pass 718 the solution along to the client 701. It is noted that as indicated at 713, the server 703 may update its cache. In particular, the new QUBO, that is the QUBO to be solved, may be stored in the cache as a new reference QUBO, as possibly dictated by a policy of the server. If such an update 713 is performed, the update 713 may comprise storing the newly built QUBO to be solved.

With reference next to FIG. 8, an example method 800 is disclosed for a scenario in which a QUBO_{diff} is sent by a client 801 but its reference is not present in the server 803. In such a case, the server asks for the QUBOₛₒₗᵥₑ or, alternatively, the correct reference. That is, in this circumstance, the server 803 does not have the reference and asks the client 801 to repeat the process.

In an embodiment, the operations 802, 804 and 806 may be the same as, respectively, operations 702, 704 and 706 shown in FIG. 7. However, upon searching 808 its cache for the reference QUBO, the server 703 determines that the reference QUBO is not present in the cache, and thus requests 810 the client 801 provide a new reference QUBO. Although not shown in FIG. 8, the server 803 may then update its cache with the new reference QUBO upon receipt of the new reference QUBO from the client 801.

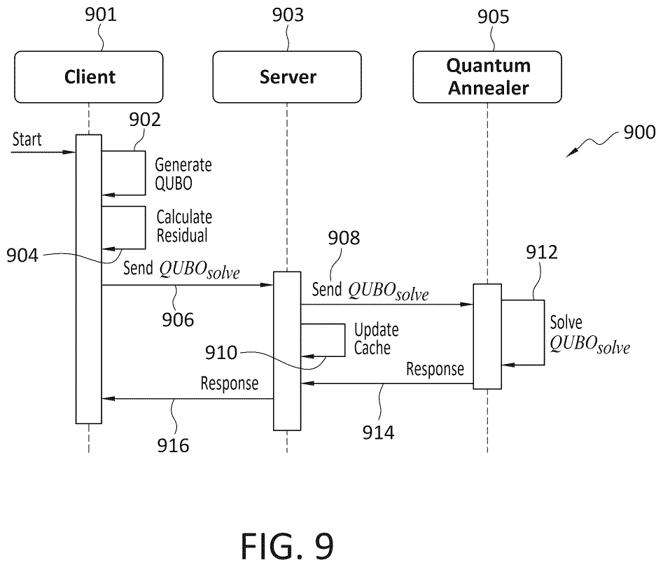

With reference now to the example of FIG. 9, a scenario is disclosed in which a client 901 sends, to a server 903, a full QUBOₛₒₗᵥₑ initially, rather than sending a QUBO_{diff}. This approach may incur a transmission penalty, but it will also make the server 903 overhead smaller as the server does not, for this iteration at least, need to rebuild the QUBO.

In more detail, the server 903 may communicate with a quantum annealer 905, in addition to communicating with the client 901. In one example, the method 900 may begin when the client 901 generates 902 a QUBO to be solved, and then calculates 904 a residual for that QUBO. The QUBO to be solved may then be sent 906 to the server 903. The server 903 may send 908 the QUBO to be solved to the quantum annealer 905, and may also update 910 its cache to include the QUBO to be solved, which may then serve as a reference QUBO. The quantum annealer 905 may solve 912 the QUBO to be solved, and return 914 the solution to the server 903, which may then pass 916 the solution back to the client 901.

### D. Example Experimental Results

In this section, a complete example of an embodiment is provided. This example considers QUBOₛₒₗᵥₑ as a problem spawned by a client device that need to be solved and QUBO_{ref} as a reference problem chosen by virtue of its similarity to QUBOₛₒₗᵥₑ. The QUBOₛₒₗᵥₑ polynomial is the following:

$${QUBO}_{solve} ( x ) = {x}_{1} + 2 {x}_{1} {x}_{2} + 3 {x}_{1} {x}_{3} + 4 {x}_{1} {x}_{4} + 3 {x}_{2} + 2 {x}_{2} {x}_{3} - {x}_{2} {x}_{3} - {x}_{4}$$

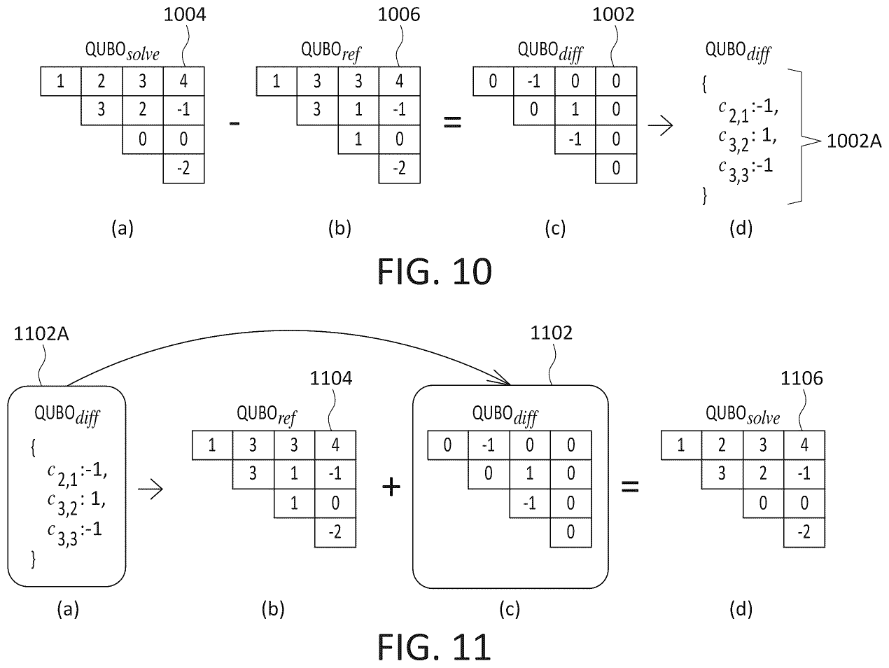

As illustrated in the example of FIG. 10, which comprises operations that may be performed by a client, (c) QUBO_{diff} 1002 is computed as the difference between (a) QUBOₛₒₗᵥₑ 1004 and (b) QUBO_{ref} 1006, where coefficients of QUBOₛₒₗᵥₑ and QUBO_{ref} are random for the sake of illustration. If QUBO diff 1002 as represented in (c) is sent to the server, no saving in data transmission is obtained since the size of the triangular matrix is preserved. An embodiment may, therefore, change the representation of QUBO_{diff} 1002 into dictionary format 1002A by eliminating all zeroed numbers as shown in (d). At the moment that QUBO diff 1002 is sent, the identifier for QUBO_{ref} 1006 is also attached in the transmission, so that the correct QUBO_{ref} 1006 is retrieved when reconstructing QUBOₛₒₗᵥₑ 1004. That is, the example of FIG. 10 shows the calculation of QUBO_{diff} 1002 by the difference between QUBOₛₒₗᵥₑ 1004 and QUBO_{ref} 1006, followed by the removal of zeroed coefficients into a dictionary representation 1002A. The values inside each cell represent the coefficient values.

On the server side, and with reference now to the example of FIG. 11, the method conducted in the client side (see FIG. 10) is reversed, that is, QUBO_{diff} (a) 1102A is transformed back into an upper triangular matrix 1102(c) then summed to QUBO_{ref} 1104(b), resulting in QUBOₛₒₗᵥₑ 1106(d), which may be provided to a quantum annealer for solution.

It is noted that the example of FIG. 11 omits the selection of QUBO_{ref} 1104 using the identifier sent by the client. In the transformation of QUBO diff 1102A, every missing element in the upper triangular matrix will be zeroed, therefore, reconstructing the QUBOₛₒₗᵥₑ 1106. Next, the quantum annealer solves QUBOₛₒₗᵥₑ and returns the obtained solution to the server, which passes the solution to the client node. Thus, as shown in FIG. 11, the reconstruction of QUBOₛₒₗᵥₑ 1106 is a simple reverse calculation of QUBO diff 1002 (see FIG. 10) performed at the client side.

It is noted that, in practice, an alternative of a client transferring the QUBO_{diff} as an upper triangular matrix would result in the transference of ten coefficients while one embodiment transmits just three coefficients by eliminating zeroed coefficients. Moreover, the choice of zero to serve as eliminating criteria is arbitrary whereas generalized versions could be designed to any number, for example, the number that most appear in QUBOₛₒₗᵥₑ and QUBO_{ref} to result in the smallest resulting dictionary. Therefore, the efficiency of one embodiment may lie primarily in the selection criteria for this number, which can, in the worst-case scenario, send all coefficients to the server. While working examples disclosed herein consider only a few coefficients, to simplify the illustrations, concrete gains in efficiency are present in scenarios with larger QUBOs, usually with thousands of coefficients and coupled with high similarity between QUBOs with same number of qubits.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.
Embodiment 1. A method, comprising: receiving, by a server from a node, a QUBO (quadratic unconstrained binary optimization) matrix; determining, by the server, whether or not the QUBO matrix is a difference QUBO matrix and, when the QUBO matrix is a difference QUBO matrix, searching a cache for a reference QUBO matrix that corresponds to the difference QUBO matrix; and when the reference QUBO matrix is found in the cache, building a QUBO matrix that corresponds to a QUBO to be solved by adding the reference QUBO matrix and the difference QUBO matrix together.
Embodiment 2. The method as recited in any preceding embodiment, wherein the QUBO matrix that corresponds to the QUBO to be solved is provided to a quantum annealer for solving the QUBO to be solved, and a solution of the QUBO to be solved is returned to the node.
Embodiment 3. The method as recited in any preceding embodiment, wherein when the QUBO matrix received from the node is determined not to be a difference QUBO matrix, the server updates the cache to include the QUBO matrix received from the node.
Embodiment 4. The method as recited in any preceding embodiment, wherein when the reference QUBO matrix is not found in the cache, the server requests the node to resend the QUBO matrix for use as a new reference QUBO matrix in the cache.
Embodiment 5. The method as recited in any preceding embodiment, wherein building the QUBO matrix that corresponds to the QUBO to be solved comprises transforming the difference QUBO matrix into an upper triangular matrix, and then summing the upper triangular matrix with the reference QUBO matrix.
Embodiment 6. The method as recited in any preceding embodiment, wherein transmission, by the node, of the difference QUBO matrix consumes less of one or more computing resources than would be consumed by transmission, by the node, of the QUBO to be solved.
Embodiment 7. The method as recited in any preceding embodiment, wherein when the QUBO matrix received from the node is determined to be the difference QUBO matrix, the difference QUBO matrix is received in a form of a dictionary, a matrix, or a flattened matrix to vector.
Embodiment 8. The method as recited in any preceding embodiment, wherein the difference QUBO matrix is associated with a unique reference identifier that enables the server to find the reference QUBO matrix in the cache.
Embodiment 9. The method as recited in any preceding embodiment, wherein the reference QUBO matrix is selected by the server from a pool of QUBO matrix configurations.
Embodiment 10. The method as recited in any preceding embodiment, wherein the reference QUBO matrix is updated every k transmissions from the node.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

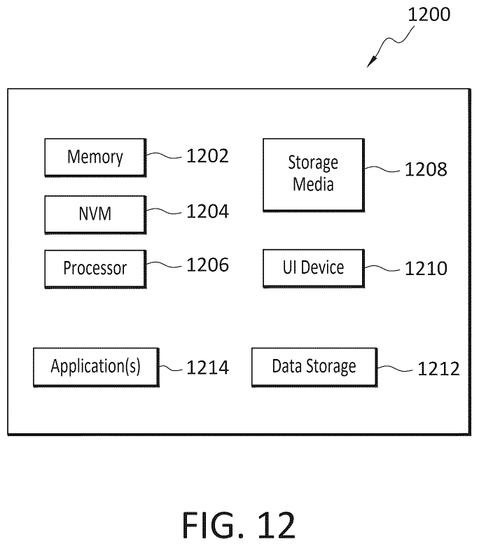

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving, by a server from a node, a QUBO (quadratic unconstrained binary optimization) matrix;
determining, by the server, whether or not the QUBO matrix is a difference QUBO matrix and, when the QUBO matrix is a difference QUBO matrix, searching a cache for a reference QUBO matrix that corresponds to the difference QUBO matrix; and
when the reference QUBO matrix is found in the cache, building a QUBO matrix that corresponds to a QUBO to be solved by adding the reference QUBO matrix and the difference QUBO matrix together.

2. The method as recited in claim 1, wherein the QUBO matrix that corresponds to the QUBO to be solved is provided to a quantum annealer for solving the QUBO to be solved, and a solution of the QUBO to be solved is returned to the node.

3. The method as recited in claim 1, wherein when the QUBO matrix received from the node is determined not to be a difference QUBO matrix, the server updates the cache to include the QUBO matrix received from the node.

4. The method as recited in claim 1, wherein when the reference QUBO matrix is not found in the cache, the server requests the node to resend the QUBO matrix for use as a new reference QUBO matrix in the cache.

5. The method as recited in claim 1, wherein building the QUBO matrix that corresponds to the QUBO to be solved comprises transforming the difference QUBO matrix into an upper triangular matrix, and then summing the upper triangular matrix with the reference QUBO matrix.

6. The method as recited in claim 1, wherein transmission, by the node, of the difference QUBO matrix consumes less of one or more computing resources than would be consumed by transmission, by the node, of the QUBO to be solved.

7. The method as recited in claim 1, wherein when the QUBO matrix received from the node is determined to be the difference QUBO matrix, the difference QUBO matrix is received in a form of a dictionary, a matrix, or a flattened matrix to vector.

8. The method as recited in claim 1, wherein the difference QUBO matrix is associated with a unique reference identifier that enables the server to find the reference QUBO matrix in the cache.

9. The method as recited in claim 1, wherein the reference QUBO matrix is selected by the server from a pool of QUBO matrix configurations.

10. The method as recited in claim 1, wherein the reference QUBO matrix is updated every k transmissions from the node.

11. A non-transitory storage medium having stored therein instructions that are executable by one or more hardware processors to perform operations comprising:
receiving, by a server from a node, a QUBO (quadratic unconstrained binary optimization) matrix;
determining, by the server, whether or not the QUBO matrix is a difference QUBO matrix and, when the QUBO matrix is a difference QUBO matrix, searching a cache for a reference QUBO matrix that corresponds to the difference QUBO matrix; and
when the reference QUBO matrix is found in the cache, building a QUBO matrix that corresponds to a QUBO to be solved by adding the reference QUBO matrix and the difference QUBO matrix together.

12. The non-transitory storage medium as recited in claim 11, wherein the QUBO matrix that corresponds to the QUBO to be solved is provided to a quantum annealer for solving the QUBO to be solved, and a solution of the QUBO to be solved is returned to the node.

13. The non-transitory storage medium as recited in claim 11, wherein when the QUBO matrix received from the node is determined not to be a difference QUBO matrix, the server updates the cache to include the QUBO matrix received from the node.

14. The non-transitory storage medium as recited in claim 11, wherein when the reference QUBO matrix is not found in the cache, the server requests the node to resend the QUBO matrix for use as a new reference QUBO matrix in the cache.

15. The non-transitory storage medium as recited in claim 11, wherein building the QUBO matrix that corresponds to the QUBO to be solved comprises transforming the difference QUBO matrix into an upper triangular matrix, and then summing the upper triangular matrix with the reference QUBO matrix.

16. The non-transitory storage medium as recited in claim 11, wherein transmission, by the node, of the difference QUBO matrix consumes less of one or more computing resources than would be consumed by transmission, by the node, of the QUBO to be solved.

17. The non-transitory storage medium as recited in claim 11, wherein when the QUBO matrix received from the node is determined to be the difference QUBO matrix, the difference QUBO matrix is received in a form of a dictionary, a matrix, or a flattened matrix to vector.

18. The non-transitory storage medium as recited in claim 11, wherein the difference QUBO matrix is associated with a unique reference identifier that enables the server to find the reference QUBO matrix in the cache.

19. The non-transitory storage medium as recited in claim 11, wherein the reference QUBO matrix is selected by the server from a pool of QUBO matrix configurations.

20. The non-transitory storage medium as recited in claim 11, wherein the reference QUBO matrix is updated every k transmissions from the node.
